(19) United States
(12) Patent Application Publication
(10) Pub. No.: US 2004/0172281 A1
(43) Pub. Date: Sep. 2, 2004

(54) SafeRite system

(76) Inventor: Sydney Devlin Stanners, Sidney (CA)

Correspondence Address: SYDNEY D. STANNERS, 102 9901 FOURTH STREET, SIDNEY, BC, V8L 2Z6, CA

(21) Appl. No.: 10/092,571

(22) Filed: Mar. 8, 2002

Related U.S. Application Data
(60) Provisional application No. 60/274,206, filed on Mar. 9, 2001.

(51) Int. Cl. G06F 17/60

(52) U.S. Cl. 705/2

(57) ABSTRACT

This invention relates to a novel two part, computer generated, bar coded, printed Rₓ, containing an illustrated patient checklist. More particularly, this invention relates to software and hardware that assist the prescriber to select a drug for the therapeutic treatment of a patient. The drug is then computer checked for patient suitability. A computer selected bar code—representing the drug name and strength is added to the Rₓ. A patient checklist—including an illustration of the drug is added to the Rₓ. The Rₓ is printed, and provided to the patient, or electronically sent to the pharmacy. The pharmacist places the bar coded Rₓ, together with the bar coded drug stock container on a bar code scanner that compares both bar codes—non-matching bar codes are immediately flagged. The patient illustrated checklist accompanies the dispensed drug and is used by the patient to determine that the drug received matches the original Rₓ.

### PROVISIONAL APPLICATION STATEMENT

This applications claims the benefit of the filing date of Provisional Patent Application. No. 60/274,206 Filing Date Mar. 9, 2001 Title: SafeRite System™

### BACKGROUND OF INVENTION

Medical errors have recently been attributed as a leading cause of death and injury in North America. Many of these medical errors relate to prescription drug mix-ups, such as the patient receiving the wrong drug, or the wrong strength of the right drug etc. Some of these errors are attributed to physician's illegible handwriting, and others to drug selection and dispensing errors in the pharmacy. Other errors result when the drug is administered to the wrong patient in hospital

In response to the issue of sloppy handwriting by physicians some products 9, 10 are coming to market that print an Rₓ. Generally speaking, these prescriptions are “written” in the physician's office and entail the use of a PDA, (or handheld computer etc.) PC, and office printer.

Although these technologies print a clearly legible Rₓ 9, 10—in either hard copy or electronically sent format—they lack design components 3 that prevent pharmacy selection errors. Nor do they provide the patient the means to determine the dispensed drug matches their prescription

The 3 Part Action Plan™

In order to prevent medication errors, the following three actions must occur:

Prevent errors that originate with the physician/writer

Prevent pharmacy dispensing errors

Involve the patient

Failure to adopt any one of these actions will result in the ongoing—and unabated—flow of medication errors.

An examination of the PDA/Rₓ products (see FIG. 11) has found all are uniform in their design approach. Each Rₓ met the criteria of part one of the 3 Part Action Plan—that is, the Rₓ's were checked and printed in the physicians office (or sent to the pharmacy electronically)—but lacked the design features necessary to provide other stakeholders in the Rₓ loop (the pharmacist, nurse and patient) a comprehensive Rₓ safety platform. Other than providing a legible (printed) Rₓ to the pharmacist, competing products did not meet the criteria set out in Part Two or Part Three of the 3 Part Action Plan and therefore do nothing to prevent errors occurring in these areas.

*Autros is a hospital system, designed to deliver dispensed drugs to patients in the ward—but lacks the capabilities of the SafeRite System to prevent drug mix-ups in the hospital pharmacy. Therefore, Autros cannot guarantee the prescribed drug reaches the patient.

### Preventable Medication Errors

### How and Why They Happen

In the Ambulatory Care Setting

Medication errors can be divided into two main categories and occur when:

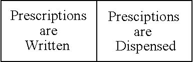

R_{X} WRITING ERRORS
The following errors occur at the time the prescription is written:

| | |
|---|---|
| Wrong Drug | The selected drug is inappropriate for the patient's |
| | medical condition |
| Strength | The correct drug-but wrong strength |
| Instructions | The correct drug-but wrong dosage instructions |
| Abbreviation | The incorrect use of an abbreviation |
| Interaction | The prescribed drug will interact with (other) |
| | current Rₓ's |
| Contraindication | Drug not compatible with patients medical condition |
| Allergy | The patient is allergic to the drug |
| Patient's name | The wrong patient name is written-sometimes |
| | the name of the previous patient |
| Verbal Orders | Orders given by telephone are a continuing source |
| | of errors |
| Handwriting | The physicians handwriting is illegible or difficult |
| | to read |

PHARMACY DISPENSING ERRORS
The following errors occur at the time that the
pharmacist fills the prescription.

| | |
|---|---|
| Handwriting | Illegible-or difficult to read-handwritten prescriptions |
| | lead to many dispensing errors |
| Verbal Orders | Orders received by telephone are often misunderstood. |
| Drug Selection | The wrong drug is selected |
| Look Alike | Selection errors occur when drug names look alike |
| Sound Alike | Selection errors occur because drug names sound alike |
| Strength | The wrong drug strength is selected |
| Instructions | Incorrect patient instructions |
| Interaction | The dispensed drug will interact with (other) current |
| | Rₓ's |
| Contraindication | Drug not compatible with patients medical condition |
| Allergy | The patient is allergic to the drug |
| Patient Chart | Various entry errors and chart mix-ups |
| Communication | The Rₓ is given out to the wrong patient |
| DIN Number | Drug DIN number is confused with look alike |
| | DIN number |

In the Hospital

Hospital medication errors are divided into three main categories and occur when:

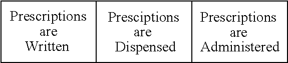

In addition to the same prescribing and dispensing errors high-lighted under Ambulatory Care, further medication errors occur in the hospital when patient identities are confused, resulting in drug mix-ups (the patient is given someone else's medication).

### BRIEF SUMMARY OF THE INVENTION

The SafeRite System™

The SafeRite System™ provides a state of the art, user friendly, low cost solution to the widespread problem of drug mix-ups. The System enables an error free Rₓ to progress seamlessly from the physician through the pharmacy to the patient. The System's design is unique and is the only Rₓ technology to address each of the 3 error prevention criteria outlined in the 3 Part Action Plan (competing products address 1 only). 9,10

Comparing the Efficacy of PDA Generated Rₓ's

Refer to FIG. 12

The SafeRite System consist of two sub-systems:

1. SafeRite™ is the hardware/software system used by the physician to ‘write’, bar code and print—or electronically transmit—the two part Rₓ.

2. SafeReader™ is the hardware/software bar code scanning system used by the pharmacist to prevent drug mix-ups in the pharmacy.

Hospital System

In addition to the benefits of SafeRite and SafeReader outlined above the hospital system includes a bedside visual display that enables the nurse to determine that the prescribed drug goes to the correct patient.

Fully Integrated

SafeRite's™ bar coded Rₓ is fully integrated with SafeReader's™ comparative scanning mechanism—resulting in a unique and highly efficient, error prevention system.

SafeRite assists the physician to quickly and accurately ‘write’ and print a prescription. By using a printed prescription format, the SafeRite System™ precludes errors associated with illegible handwriting.

SafeRite prints a bar code—representing the drug's name and strength—on the Rₓ.

SafeReader's innovative design enables the pharmacist to quickly carry out a bar code comparison check of the Rₓ and drug selected from stock. This crucial step prevents pharmacy selection errors.

Finally, the Patient Checklist portion of the Rₓ encourages patient participation in the prescription loop by providing the patient an easy to follow sequenced checklist.

Safety features—incorporated into the Rₓ—are available at each crucial [decision making] juncture of the Rₓ loop.

The efficiencies provided to physicians by the SafeRite System™ will discourage giving verbal Rₓ orders by telephone.

The SafeRite™ Rₓ will conform to all federal and state/provincial requirements.

Competing Rₓ products offer a printed Rₓ, but do not incorporate a bar code (pharmacy protection) or patient checklist, nor do they offer a visual check for hospital use.

The SafeRite System™ provides end users with a powerful safety technology. Benefits accruing to the end user and health care system are substantial financial paybacks resulting in the cessation of deaths and injuries to patients, together with the professional satisfaction of providing the patient a risk free (medication) environment.

### DRAWINGS

FIG. 1 Illustration showing the two part SafeRite Rₓ.

FIG. 2 Schematic showing sequence of SafeRite Rₓ and 3 Part Action Plan FIG. 3 Illustration showing a SafeRite generated Rₓ in which a Generic substitution takes place. The green bordered label is affixed to Box Four.

FIG. 4 Illustration of Green bordered generic label see FIG. 3

FIG. 5 Illustration of bar coded label. Label is attached to any [non-SafeRite] Rₓ. For example: to the reverse side of Rₓ's shown in FIGS. 8 and 9

FIG. 6 Schematic of SafeRite/SafeReader sequence of use in Hospital and Clinical settings.

FIG. 7 Illustrated bedside visual display for Hospital and Clinical use.

FIG. 8 Schematic showing carry case for printer and PDA

FIG. 9, 10 Rₓ samples of competitive computer generated Rₓ products.

FIG. 11 Chart showing Vendors of Hand-held Electronic Prescribing Products FIG. 12 Chart comparing efficacy of PDA generated Rₓ's.

### DETAILED DESCRIPTION OF INVENTION

The SafeRite System™ consist of two sub-systems:

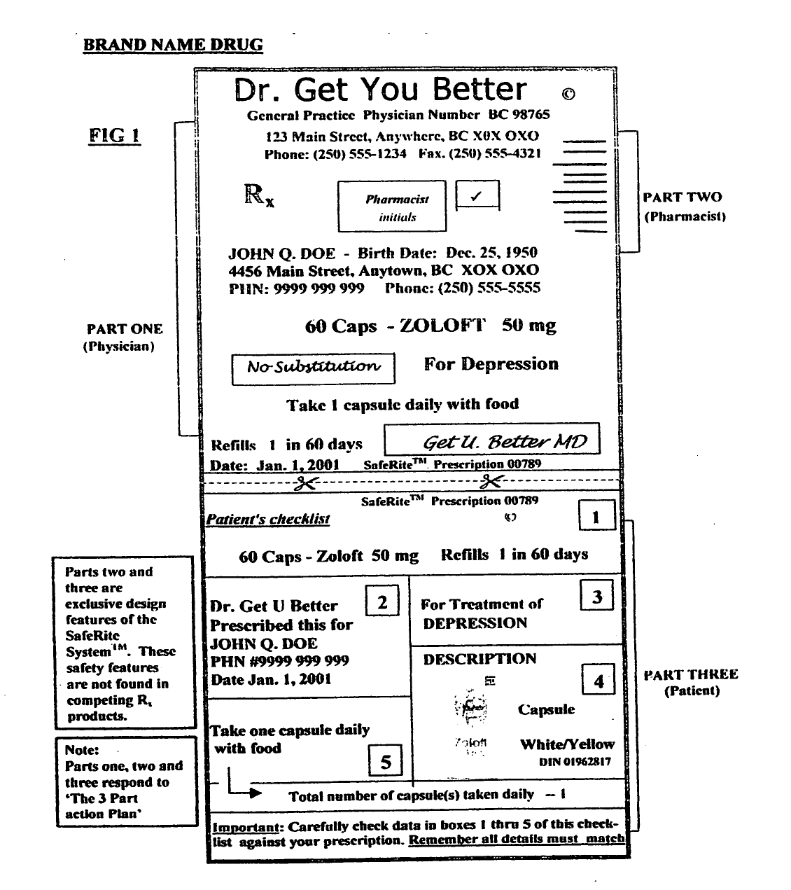

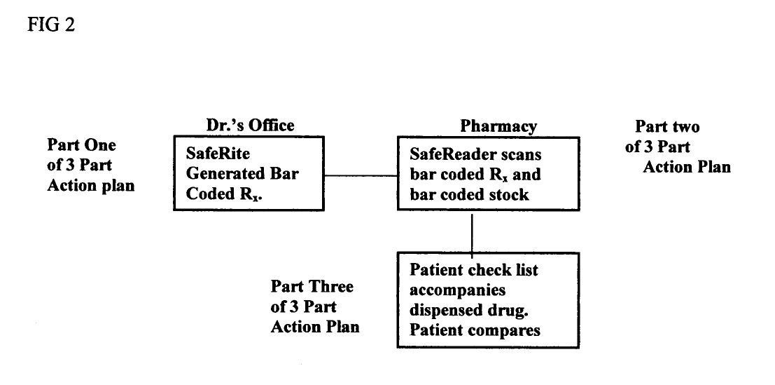

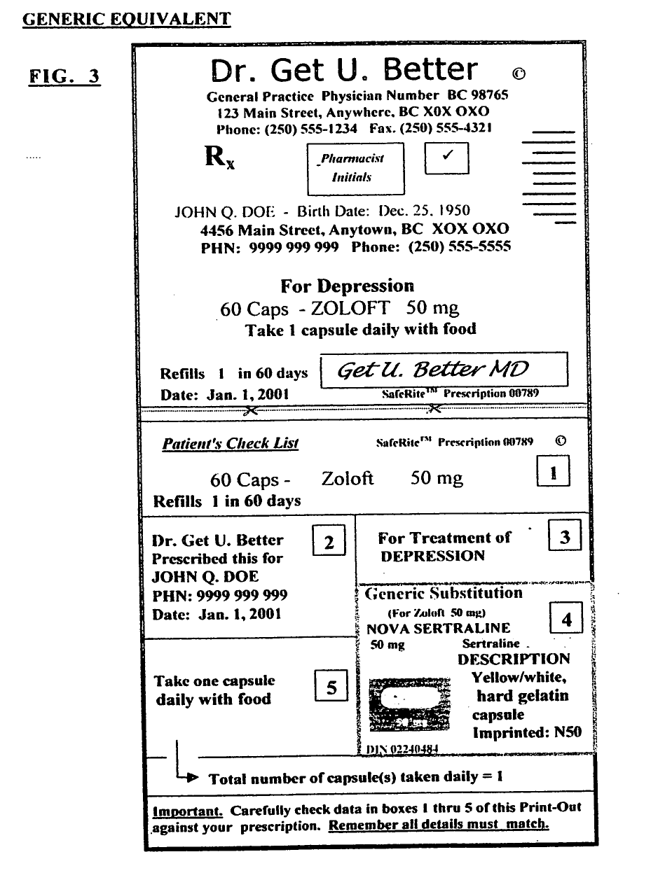

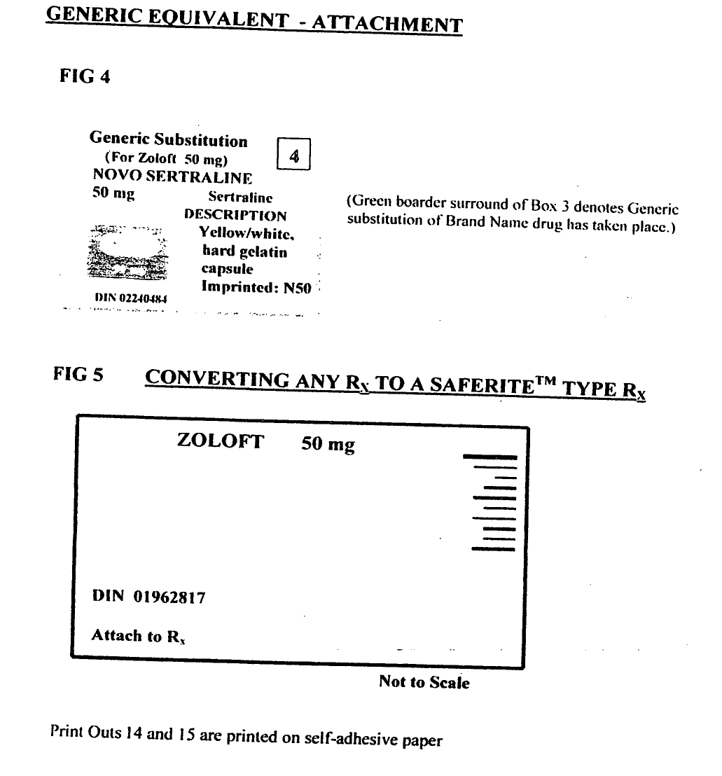

1. SafeRite™ is the hardware/software system used by the physician to ‘write’, bar code and print—or electronically transmit—the two part Rₓ. FIG. 1, 11

2. SafeReader™ is the hardware/software bar code scanning system used by the pharmacist to prevent drug mix-ups in the pharmacy. 12

Hospital System

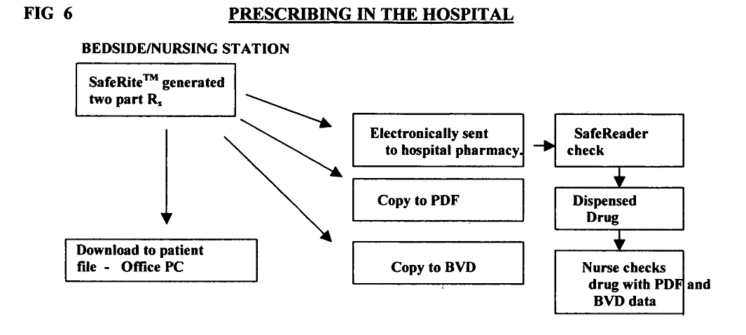

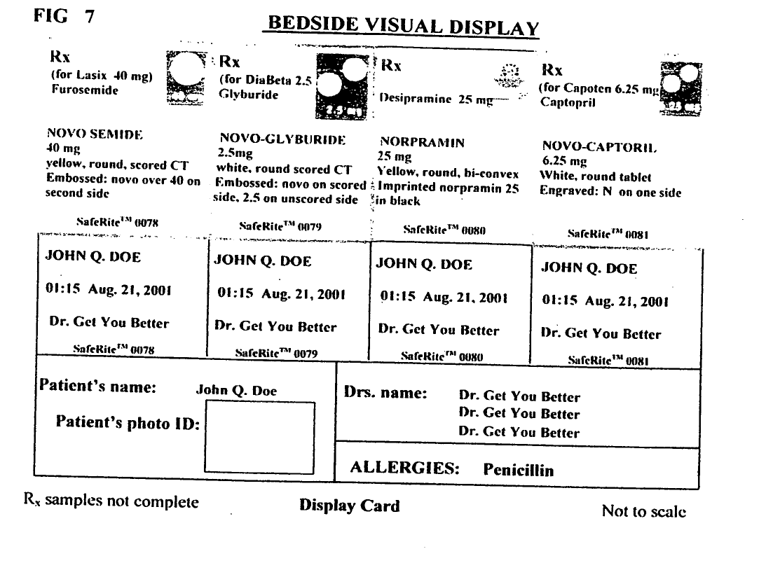

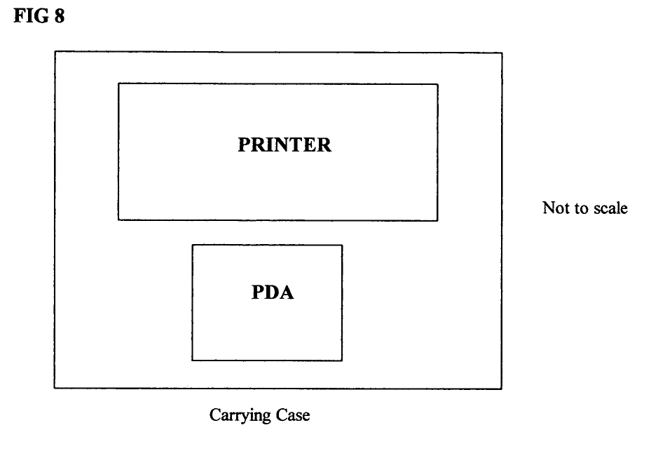

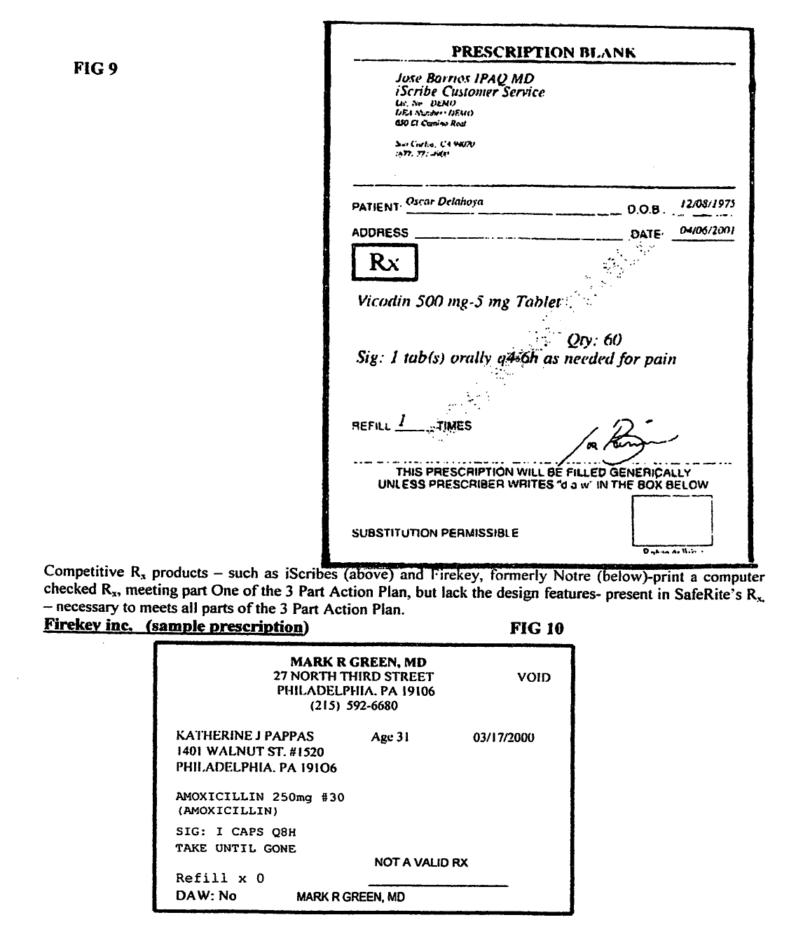

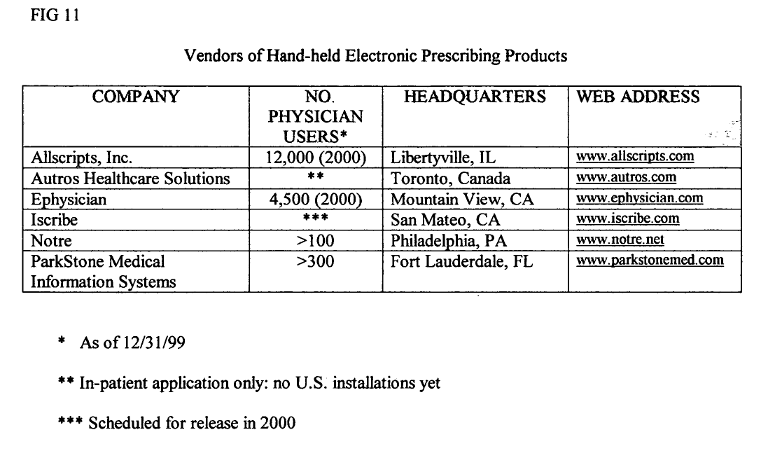

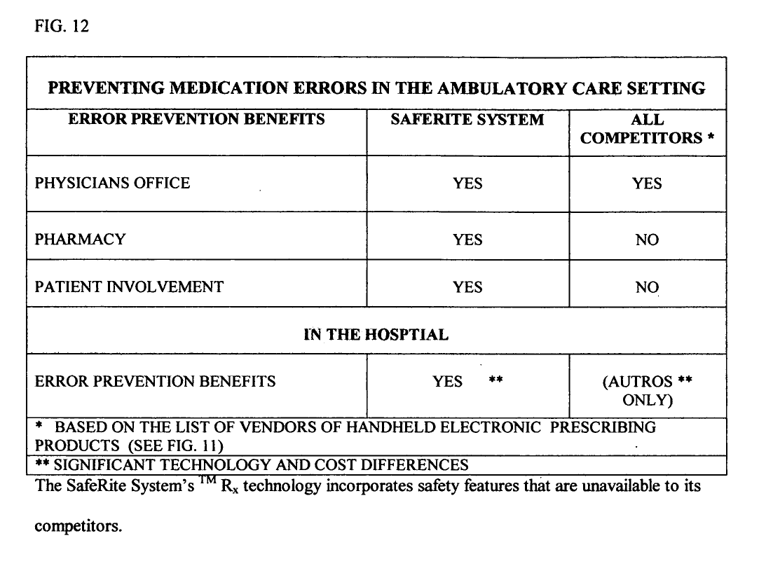

In addition to the benefits of SafeRite and SafeReader outlined above, the Hospital System FIG. 6 includes a bedside visual display (BVD) 17 that enables the nurse to determine that the prescribed drug is administered to the correct patient.

### The SafeRite Rₓ

Prescription Design

The design of the SafeRite™ Rₓ involved meeting the following four part criteria:

1. Produce a computer generated (printed) Rₓ FIG. 1

2. Build in safety features and increase content 2, 3, 4

3. * Involve the patient in a final cross-check of the dispensed drug 4 * Note: As part of a discussion on how to prevent drug mix-ups—“and make the patient their own best defense”—Michael Cohen, of the ISMP, states: “I think it's becoming very, very important, for the consumers to be informed about what their medications are for, what the names are, how to take them and what the doses are.” 4

4. Provide a user-friendly system, requiring minimum Rₓ input

The patient's portion of the SafeRite™ prescription leads the patient through the easy to follow Patient Checklist. 4

Rₓ Features

Clear, large, easy to read printed Rₓ 2, 4

Bar coded—for pharmacy use 3

Unique two part design—includes patient checklist 2, 4

Flexible format—print and/or electronic transmission 11

Conforms to the “3 Part Action Plan” 2, 3, 4

Brand Name/Generics

To prevent generic substitution, the physician must write the appropriate state/provincial statement requirement i.e. No Substitution 5 or Dispense as Written etc. in the box provided.

Preventing Look Alike/Sound Alike Errors

A simple, effective, low cost method of preventing “look alike/sound alike” medication errors—and other selection errors—while filling the Rₓ in the pharmacy 12, is by incorporating a bar code—containing the drug's brand name and strength—into the Pharmacist's Print Out portion of the Rₓ. 3 The Rₓ bar code duplicates the drug's brand name and strength, contained in the bar code appearing on the drug's stock container.

To determine the drug taken from stock matches the Rₓ, the pharmacist scans the bar codes appearing on both the Rₓ and the drug's stock container 12, an incorrect selection—of the drug or drug strength—is immediately flagged:

Note: Scanning is accomplished by using a handheld scanner or a dedicated scanning unit. The unit facilitates the check by scanning both bar codes more or less simultaneously. The unit's program accepts matching codes, but rejects (flags) non-matching codes. The pharmacist rectifies an error by selecting the correct drug/stock container. Matching bar codes allow the program sequence to continue.

How Many Tablets a Day?

The Rₓ instruction—take 1 tablet daily with meals—can be thoroughly confusing to some patients. Do they take 1 tablet each day OR 1 tablet with each meal? To remedy this common misunderstanding, an information block is added to the bottom of the Patient's Checklist.

For example, the Rₓ for Zoloft—take 1 capsule daily with meals—would read: 7

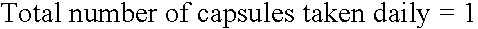

The Rₓ for Flagyl—take 2 tablets 3 times a day with meals—would read:

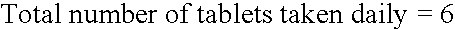

While the Rₓ for Tylenol 3—take 1 to 2 tablets 4 times a day as needed—would show the daily maximum allowable dosage:

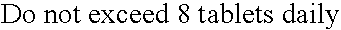

### System Requirements

Physician's Office (Part One) SafeRite™¹¹

Hardware

PDA—MODEM—CRADLE

PC

PRINTER

Note: PDA can mean any type of computer. The prescriber can also use the office PC to “write” the Rₓ.

The PDA communicates with the PC and printer by wireless transmission (or infrared).

Software

Prescription software for PDA and PC

PDA/PC interface software

Sequence of Use

The physician calls up the patient's name/file, from the office PC, on their PDA. 11

Using their PDA the physician enters the reason for treatment—ie depression 10—and is given a menu of appropriate drugs, then electronically “writes” the prescription by selecting drug, dosage, quantity, and patient instructions 2

The program checks that the selected drug is correct for the patient's medical condition, contraindications, for drug interactions with other current prescriptions and for correct patient instructions. Allergies are flagged

Check patients health plan formulary for drug approval

A bar code representing the drug brand name and strength is transferred to the Rₓ 3

The physician then reviews Rₓ, prints and signs (if sending by computer fax etc—the signature is computer generated)

To print: the PDA communicates wirelessly with the printer 11, 12

To send to the pharmacy: the PDA sends the Rₓ to the PC. The PC electronically sends the Rₓ directly to the pharmacy via the Internet over a secured line. (Electronic Rₓ transmissions are permitted in most states, and will be soon allowed in Canada.)

By using their PDA with WAN (wireless wide area network) capability, the physician is able to transmit, or fax an Rₓ to a pharmacy from remote locations

The transmitted data is encrypted, complying with patient confidentiality issues

To facilitate refills: the physician uses their PDA to call up the patients' file

Highlights

Access to patient's file

Printed Rₓ—prevents pharmacy errors caused by poor handwriting. Eliminates time consuming calls from pharmacists. Some physicians report saving 1-2 hours daily when using similar products

Undertakes complete check of the Rₓ data

Flags allergies

Checks health plan formulary for drug authorization

Choice of Rₓ format—printed in the physician's office and/or electronically sent to the pharmacy

The Rₓ data is transferred to the patient file on office PC

Speeds up the refill process. Rₓ data from patient file instantly available on PDA

Prevents patient morbidity and mortality events

Reduces the chance of lawsuits

Reduces malpractice insurance premiums

Drug safety notices etc, flagged on the physicians office computer, are transferred to the SafeRite System—continually upgrading the System's software

Conforms to the 1st part of the “3 Part Action Plan” 2

In the Pharmacy (Part Two) SafeReader™

Hardware

SafeReader™ (combination bar code reader/printer) 12 provides an automated bar code comparison scan of the R_{x 3} and drug's stock container. Prints Box four illustrated generic data 14

SafeReader™ an indispensable pharmacy tool, which guarantees the drug taken from stock matches the R_{x 3} in both selection and strength 12

Software

Compares Rₓ bar code 3 with bar code displayed on drug stock container 12

Accepts generic substitutes to brand name drugs

Transfers—Brand Name or Generic—scanned stock container's bar code to pharmacy working copy and patient Rₓ file

Sequence of Use

Brand Name drug selection: To determine the drug taken from stock matches the Rₓ, the pharmacist places both the Rₓ and the drug stock container on the SafeReader™ unit 12

SafeReader™ quickly performs a dual bar code scan—comparing drug name(s) and strength(s). Non matching data is immediately flagged 12

SafeReader™ prints a validation (check) mark on the Rₓ. 9. The pharmacist subsequently places his/her initials in the box provided 8

SafeReader™ then transfers the drug's bar code to the pharmacy working copy and patient Rₓ file

The Brand Name drug's bar code acts as a master bar code, and matches all generic substitute bar codes 3

Generic drug selection: the generics' stock container is placed on SafeReader™ 12 and the generic container's bar code is scanned against the Rₓ's 3 bar code. SafeReader™ then transfers that [specific] generic drug's bar code* to the pharmacy working copy and patient's Rₓ file. SafeReader prints a new Box Four information—containing the generic drug's data and illustration—onto an adhesive sticker, 15 which the pharmacist places over the original Box Four 6,14 (containing Brand Name drug data) on the Patient Checklist. * The bar codes of allowable generic substitutions [to a given Brand Name drug] are not interchangeable. Only the originally dispensed generic drug's bar code will subsequently be accepted by SafeReader, thereby preventing mix-ups of [allowable] generic drugs when refilling an order.

On refills, the drug's [specific] bar code—from the patients' Rₓ file—is transferred to the pharmacy working copy

The bar coded working copy is placed on SafeReader™ 12—in the same manner as the original Rₓ 3—and scanned against the drug's stock container—preventing refill mix-ups

At the time the generics' bar code is transferred to the pharmacy working copy and patient Rₓ file, the Brand Name's bar code data—imprinted on the Rₓ—is automatically invalidated by SafeReader, thereby, isolating the generics' [specific] bar code for future scanning checks. Likewise, when a Brand Name drug is to be filled—and its bar code data transferred from the Rₓ to the pharmacy working copy and patient Rₓ File—the allowable generic substitution information—contained in the Brand Name's master bar code—is invalidated by SafeReader. Therefore, only SafeReader, assuring correct drug selection recognizes the bar code belonging to the Brand Name drug.

Additional Rₓ Bar Code(s)

Another bar code—containing patient ID etc. is added to the Rₓ—when scanned by SafeReader, this bar code opens up the (pharmacy) patient Rₓ file, preventing patient chart mix-ups and Rₓ/patient entry errors. This feature will facilitate further [scanned] safety checks. Other bar codes are added as necessary.

Generic Equivalent—Attachment

SafeReader™ II—an Intermediate Solution

SafeReader™ II's software program, in essence, is the drug selection/bar coding portion of the physicians SafeRite™ software program. SafeReader™ II equips the pharmacist with a powerful safety tool. SafeReader™ II's program converts any Rₓ to a SafeRite™ [bar coded] type Rₓ. To accomplish this, the pharmacist enters the Rₓ drug name and strength into the pharmacy computer—the [SafeRite II] program converts this data to a bar code, which is printed together with drug name and strength, on an adhesive sticker 16, and affixed to the Rₓ The bar coded Rₓ [attachment] and drug stock container are subsequently scanned by SafeReader™ 12 to assure correct drug and strength selection. The program then prints an abbreviated, illustrated Patient Checklist which accompanies the dispensed drug. 4

On the other hand, pharmacists who receive a SafeRite™ Rₓ 2, in a non SafeReader™ pharmacy, will benefit from SafeRite's™ printed Rₓ and Patient Check-List. 4

Printing Options

The primary function of SafeReader™ is to provide a comparative bar code scan of the bar codes appearing on the R_{x 3} and drug stock container. Printing is accomplished by incorporating a printer together with the bar code scanning mechanism into a single, stand-alone unit, or the printer is connected to the SafeReader unit. The printer is calibrated to print a generic attachment 14 that affixes to Box Four of the Patient Check-List. Alternatively SafeReader™ functions solely as a bar code scanner, and the pharmacy printer undertakes printing the Box Four generic attachment. 14

The pharmacist separates the two parts of the Rₓ. 2, 4. The Patient Checklist 4 is attached to the dispensed drug vial etc.

The pharmacist, together with the patient, goes through the patient Checklist. 4

Highlights

Easy to read, printed Rₓ—prevents errors caused by poor handwriting—eliminates the need to call physician for clarification 2

Eliminates the need to call physician regarding missing Rₓ data: (ie quantity) 2

An infallible method of preventing drug selection errors 3

Patient diagnosis 10 prominently displayed on Rₓ—enables pharmacist to determine that the prescribed drug matches the patient's medical condition. (The MD may omit this information)

Facilitates refills—scans [bar-coded] working copy with [bar coded] stock container.

Prevents refill drug mix-ups

Prevents patient morbidity and mortality events

Reduces the chance of lawsuits

Reduce malpractice premiums

Conforms to the 2^{nd} part of the “3 Part Action Plan” 3

The Patient (Part Three)

The patient is the ultimate beneficiary of the SafeRite System. Each feature of the Systems' technology is designed to prevent patient injury and death caused by medication errors. In doing so, the System confers many benefits to the other stakeholders in the Rₓ loop: namely the physician 2, pharmacist 3, and nurse. 17

Hard Copy

Patient Print-Out portion of the Rₓ (Patient Checklist) 4

The Patient's Checklist accompanies the dispensed Rₓ

Sequence of Use

On receiving the dispensed drug, the patient—together with the pharmacist—follows the Checklist to compare the Patient Checklist data with the information printed on the prescription vial/container. 4

Finally, the patient and pharmacist visually check that the dispensed medication matches the drug illustration in Box Four of the Checklist 6. In many cases the illustration is life-size.

This third and last step of the 3 Part Action Plan—which takes only a few moments—is critical to the success of the error prevention program, and at the same time, conforms to [pharmacy] professional patient counseling requirements.

Highlights

Patient receives correct drug

The System accesses pharmaceutical companies offering no cost/low cost drugs to patients encountering financial hardship.

The patient is involved in a crucial step of the Rₓ loop

Is guided through the checklist sequence 4

Conforms to and completes all actions in the “3 Part Action Plan” 4

Reduces patient morbidity and mortality events.

In the Hospital

Hardware:

PDA

Printer

SafeReader™

Bedside Visual Display Kit 17

The hospital system requirements are much the same as those for the physician and pharmacy.

Sequence of Use 16

Doctor makes rounds, then using SafeRite™

Selects and prints Rₓ The Rₓ is either printed at the patient's bedside by using a handheld printer, or at the nurse's station (Drs. Desk)

Copy of Patient Checklist (hospital version) placed in Bedside Visual Display 17 (BVD)*

2^{nd} copy of Rₓ and Patient Checklist placed in Patient Drug File (PDF) at nurses' station.* * When a generic substitution of the prescribed drug has taken place, the nurse attaches copies of the illustrated generic attachment 14 to Box Four of the Patient Checklist of the BVD 17 and PDF. Generic attachments are printed once only, and accompany the drug the first time it is dispensed to the patient.

The doctor transmits the Rₓ to the hospital pharmacy by fax, LAN or WAN—or submits a printed copy

Rₓ data subsequently downloaded to patient's file on physician's office PC

Highlights

In addition to:

Physician Highlights

Pharmacy Highlights

Patient Highlights

Additional Hospital Highlights:

Writing and printing the Rₓ at the patients bedside

Patient Drug File (PDF). Enables check of Rₓ received at Nursing Station

Bedside Visual Display 17 (BVD). Provides nurse with illustrated Rₓ information

Infallible and inexpensive method of administering the right drug to the right patient

In the Hospital Pharmacy

The pharmacist scans the Rₓ and drug stock container 12—assuring correct drug and strength selection, prints generic sticker 14—when necessary—and includes them with the patients drug. (Alternatively, a copy of the Patient Checklist accompanies the Rₓ, in which case, the pharmacist attaches the generic sticker 14 to Box Four of the Checklist, in the usual fashion (and an extra one for the PDF). The nurse peels off one of the stickers, attaches it to the PDF, then either exchanges the Patient Checklist for the one in the BVD 17, or peels off the remaining Box Four sticker, and attaches to the BVD 17 copy.) The hospital pharmacist may elect to convert a non SafeRite Rₓ to a bar coded Rₓ 16.

Nursing Station

Dispensed drug received at nursing station

If generic 14—Box Four sticker attached to PDF

Drug checked against PDF WARD

When administering the Rₓ to the patient in the ward, the nurse checks that the dispensed drug matches the [illustrated] Rₓ data included in the Patients Checklist, displayed in the BVD 17

Note: By following the unique and inexpensive BVD 17 drug administering protocol—which takes only a few moments—the nurse is assured that the right drug is given out to the right patient, and that the drug and drug strength complies with the written Rₓ order.

Patient data, such as condition/illness etc., is contained on the reverse side of the patients' nametag 17. Tags slip out easily for fast reference. In order to accommodate additional Rₓ's, additional display cards are hung beneath the original card 17. One card will contain recent medication history.

Routing information: ie Fl.5 Rm.123 Bd. C—is displayed on the Patient Checklist portion of the Rₓ, and accompanies the prescribed drug(s). The physician adds routing data at the time the Rₓ is written [on the PDA].

Option: The Rₓ/Checklist is folded back to back and placed in the clear plastic pouch of the BVD 17. Only the illustrated Checklist portion remains visible 17. To read the Rₓ, the doctor/nurse checks the reverse side of the BVD display card.

In order to facilitate writing the prescription at the patients' bedside, a custom designed case 18 will carry the PDA and printing unit, allowing hands free operation.

What is claimed is:

1. Prescription form generated in multiple parts
A One part of the prescription form is printed and contains a bar code representing the name of the prescribed drug and it's strength.
B. Another part of the prescription form contains pertinent information relating to the prescribed drug.
C. The prescription form contains an illustration of the prescribed drug.
D. The prescription form sent by electronic transmission.
E. A prescription form that is dividable.

2. A Prescription form as claimed in claim 1 is used as a checklist.

3. A bar code scanning means

4. A bar code scanning means as claimed in claim 3 that compares the bar coded prescription form as claimed in claim 1 with the bar code appearing on the prescribed drugs stock bottle.

5. A software program that converts a brand name drug to an illustrated generic format.

6. An illustrated gummed label to be affixed to a checklist as claimed in claim 1 containing a description of the generic drug as claimed in claim 5.

7. A software program that bar codes and prints a label to be affixed to any prescription

8. An illustrated checklist for use as a bedside display containing the patient identifying photograph.
